(19) United States
(12) Patent Application Publication
(10) Pub. No.: US 2015/0199627 A1
(43) Pub. Date: Jul. 16, 2015

(54) METHOD AND APPARATUS FOR OPTIMIZING A MULTI-DIMENSIONAL SPACE

(71) Applicant: SQI3 Solutions Limited, London (GB)

(72) Inventors: Matthew Elliot GOULD, Auckland (NZ); Gerald HENRY, Nassau (BS)

(21) Appl. No.: 14/670,788

(22) Filed: Mar. 27, 2015

Related U.S. Application Data
(63) Continuation of application No. PCT/GB2012/000756, filed on Sep. 28, 2012.
Application No. PCT/GB2012/000756 is a continuation of application No. PCT/GB2012/000755, filed on Sep. 28, 2012.
Application No. PCT/GB2012/000755 is a continuation of application No. PCT/GB2012/000754, filed on Sep. 28, 2012.
Application No. PCT/GB2012/000754 is a continuation of application No. PCT/GB2012/000752, filed on Sep. 28, 2012.
Application No. PCT/GB2012/000752 is a continuation of application No. PCT/GB2012/000751, filed on Sep. 28, 2012.
Application No. PCT/GB2012/000751 is a continuation of application No. PCT/GB2012/000750, filed on Sep. 28, 2012.

(51) Int. Cl. G06Q 10/06; G06Q 10/08

(52) U.S. Cl. CPC G06Q 10/0631; G06Q 10/087

(57) ABSTRACT

Various methods are provided for enabling the optimization of a layout of a three dimensional space. One example method may include determining a margin value for a plurality of units as a function of a volume occupied by the plurality of units in a three dimensional space. A method may further include applying one or more optimizations to the plurality of units, the one or more optimizations configured to assign a spatial location in the three dimensional space to one or more units of the plurality of units based at least in part on the one or more optimizations applied and the margin value assigned to the plurality of units. A method may further include rendering a visualization of a recommended layout based on the spatial location of the one or more units of the plurality of units.

### CROSS-REFERENCE TO RELATED APPLICATIONS

This application is a continuation of International Application Nos. PCT/GB2012/000756, PCT/GB2012/000755, PCT/GB2012/000754, PCT/GB2012/000752, PCT/GB2012/000751, and PCT/GB2012/000750, all of which were filed Sep. 28, 2012, which are hereby incorporated herein in their entirety by reference.

### TECHNOLOGICAL FIELD

Embodiments of the present invention relate generally to retail establishment technology and, more particularly, relate to a method, apparatus, and computer program product for a optimizing a multi-dimensional space.

### BACKGROUND

In various industries, to include the finance industry, a recent trend has emerged highlighting an evolution of technologies that facilitate a more strategic, graphical view of business transactions. In particular, software applications and other technology related to financial analysis have recently developed in complexity and precision to keep pace with the increase in structure and type of investment instrument offered. Just as financial traders and corporate strategists are demanding better commercial insight from the software applications and available technology, other industries are generally moving beyond the spreadsheets and daily static financial reports of traditional software products.

In some examples, the retail sector has traditionally lagged behind other business sectors in analytics software, technology and reporting. The retail sector continues to lag even though the retail sector accounts for over 83% of world trade transactions occurring within a physical store. In these example stores, even with the increase in just in time ordering (e.g. real time inventory tracking) and other innovations in the sector, little to no data is retained with respect to the contribution of a stock keeping unit (SKU) or category of SKU's to the physical stores' profitability.

Generally, physical stores and other virtual stores are still organized on the basis of heuristics and other metrics that rely on historical experience by a manager or stocking director. For example, even the most sophisticated retail chains default to standardizing planograms (e.g. a diagram or model that indicates the placement of retail products on shelves in order to maximize sales) and layout schematics. In some example cases, planograms may be the same across stores nationwide, across multiple distinct regions and/or the like, but such generalization results in a non-optimized layout of products.

Such a concern is generally referred to as the retailer's dilemma. The retailer's dilemma describes a retailer's constant struggle to place products (e.g. SKUs) in locations to maximize profitability. Generally, the methods used by corporate retail chains to arrange products within their retail space remain heuristic and, at best stilted, in terms of cycle (e.g. weekly, monthly and quarterly as opposed to in real time). Enterprise resource planning (ERP), customer relationship management (CRM) and point of sale (POS) systems that most retailers use are configured to facilitate accounting and efficient stock control; however, these systems lack the analytics needed to solve the retailer's dilemma. Namely, these systems fail to describe what to include in a store and what to place where to optimize sales returns in real time.

Some example systems, such as the Oracle® Retail system, focus on consumer demand as a means to optimize store level inventory. For example, the Oracle® Retail system uses local demand, buying preferences and/or price points to make decisions on store level assortments of SKUs. Other retail systems, such as the Mathecsys system provides virtual shelf monitoring to ensure the correct placement of objects as defined by a planogram and also include methods for automatic reordering of products based on the virtual shelf monitoring. Each of these solutions disadvantageously, for example, focus on inventory levels and, in particular, focus on historical demand as evidenced by lack of inventory.

### BRIEF SUMMARY

Methods, apparatuses, and computer program products are provided herein to enable a user to optimize a visualization of a three dimensional space, such as the three dimensional space of a retail store. In some example embodiments, the optimized three dimensional space may be generated from a current layout of the three dimensional space, a list of available SKUs for stocking in the three dimensional space, a list of available categories for stocking in the retail space and/or the like. The optimized three dimensional space is configured, in some example embodiments, to place or otherwise stock one or more available SKUs, one or more available categories and/or the like, such that the resulting layout maximizes volumetric area that contributes to positive or increased margin. For example, the optimized three dimensional space may be arranged based on an increase in volumetric area that contributes to margin, a volumetric area that exceeds a predetermined threshold that contributes to margin, a greatest volumetric area that contributes to margin when compared to other layouts and/or the like.

In some example embodiments, the optimized store layout may be interactive, such that a user is enabled to arrange stock keeping units and/or categories via the user interface and/or based on one or more optimizations. In response to a user interaction with the updated layout, the user interface may further be configured to display predictive results, historical trends and/or other data. In some examples, the optimized store layout is configured to function as a real time or near real time guide for a store layout (e.g. a visualization) in a three dimensional space.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a schematic representation of a system that may benefit from some example embodiments of the present invention;

FIGS. 2a-k illustrate a plurality of screen shots of a three dimensional space optimization system in accordance with some example embodiments of the present invention;

FIG. 3 illustrates a block diagram of an apparatus that embodies a three dimensional space optimization system in accordance with some example embodiments of the present invention; and

FIGS. 4-16 illustrate flowcharts that may be performed by a three dimensional space optimization system in accordance with some example embodiments of the present invention.

### DETAILED DESCRIPTION

Example embodiments will now be described more fully hereinafter with reference to the accompanying drawings, in which some, but not all embodiments are shown. Indeed, the embodiments may take many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments, to refer to data capable of being transmitted, received, operated on, and/or stored. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

As used herein, the term “circuitry” refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a computer, mobile device or server, to perform various functions); and (c) to circuits, such as a microprocessor(s) or a portion of a microprocessor(s), that require software or firmware for operation, even if the software or firmware is not physically present. This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware.

In some examples, volumetric analysis is a methodology and analysis model that uses quantitative data to maximize margin from available volume in a three dimensional space. For example, a stock keeping unit (SKU) with high sales, high volume and low margin may be preferred in some cases, but not in all cases, over a stock keeping unit with low sales, low volume and high margin. The analysis is driven by a calculated margin value (e.g. gross margin, net margin, a difference between selling price and cost, (Revenue−Cost of goods sold)/Revenue, Unit margin ($)/Selling price per unit ($), Unit margin ($)/Selling price per unit ($) and/or the like) as a function of volume or other unit that representative of area in a two or three dimensional space. Volumetric analysis is configured to enable the system, an operator, user or the like, to arrange the available volumes in a three dimensional space in terms of margin received based on volume occupied. As such, the system, the user, operator or the like, may categorize SKUs, may determine each category and/or each SKU to stock to maximize sales and margin, and/or allocate and assign space to each category and/or each SKU.

In some examples and as described herein, a user, such as a store owner/manager, may enter details of a three dimensional space, such as a store. The details may be entered in the form of a drawing of the store in a user interface, a listing of coordinates that geometrically describe the store and/or the like. A category of products (e.g. soups) may then be allocated space within the total shelf and display space available (e.g. three dimensional space characteristics) in the three dimensional space. In some examples, category space is configured to be allocated alongside a space provided to other related categories (e.g. tinned vegetables).

In further examples, trading data is received, such as but not limited to sales per category data over a specific period (days/weeks/months/years), live sales data received directly from a point of sale system and/or other data may be received as is described herein. In further example embodiments, customer behavior metrics may be maintained and may be used to weight the optimizations, such as category ranking, category placement or the like. In some examples, customer behavior metrics may be derived from tracking customer store visits and accepted category layout rankings. For example, products within a 30 degree arc of five foot seven are more likely to be selected over matching products presented outside of this arc. In other words customers are more likely to choose products that are at their eye level.

In operation and according to some examples, a user, such as a store manager, may select to optimize a three dimensional space by selecting ‘Optimize by Category’ in a user interface. In response, the three dimensional space may be allocated to the one or more categories in terms of the margin values each is contributing to the overall financial performance of the three dimensional space. One or more additional optimizations may be executed in addition to, in combination with, or in alternative to the above recited optimize by category optimization. In some example embodiments, the three dimensional space may be first optimized based on categories within a business unit and then SKU or products within a category.

Real time or near real time recommendations as to the potential of revised layouts of categories and/or the allocation of more or less of the overall retail space available to each of the categories may also be provided. These recommendations may be presented visually in a user interface in some example embodiments. In some examples, the user interface may include a visual representation of the original three dimensional space, to include structures, as drawn by the store owner/manager as the basis for the recommendations. In some examples, the category optimization information may then be combined with other optimizations, such as a SKU optimization, to generate a four dimensional (e.g. spatial location and time period) planogram for the three dimensional space. Alternatively or additionally, the recommendations may be given via another modality or in combination with one or more modalities (e.g. text, speech and/or the like).

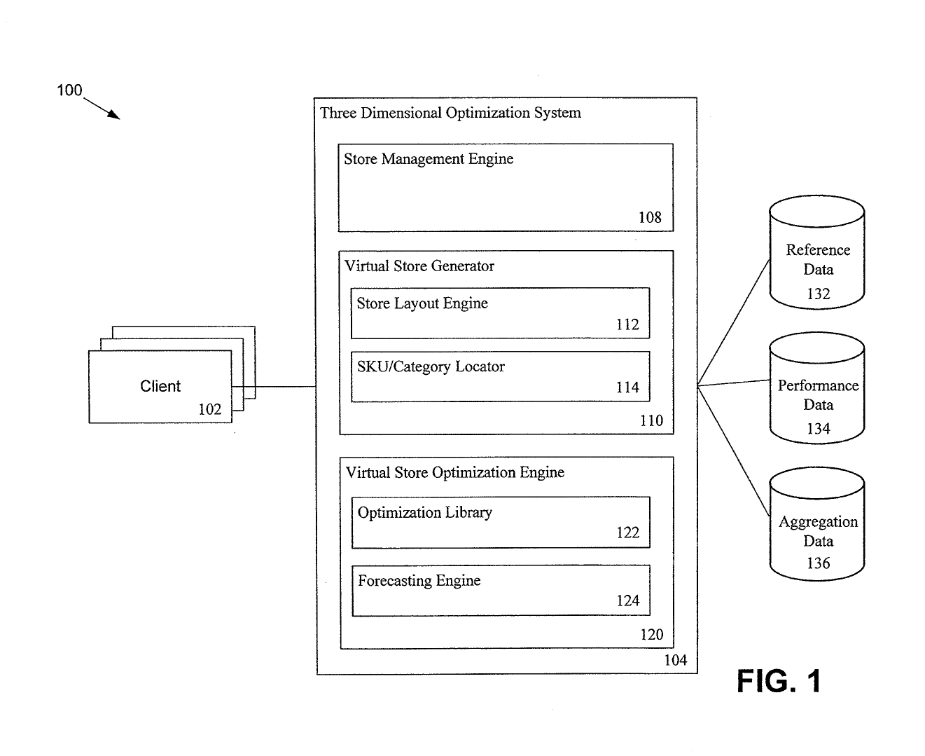

FIG. 1 is an example block diagram of example components of an example three dimensional space optimization environment 100. In some example embodiments, the three dimensional space optimization environment 100 comprises a plurality of clients 102 that are configured to access or otherwise interact with one or more three dimensional optimization systems 104 (e.g. a code module, component, circuitry or the like) and one or more data sources, such as but not limited to reference data 132, performance data 134 and aggregation data 136. The components of the illustrated three dimensional space optimization environment 100 are configured to provide various logic (e.g. code, instructions, functions, routines and/or the like) and/or services related to the real time and/or near real time optimization of a three dimensional space.

In some example embodiments, the three dimensional optimization system 104 is configured to combine spatial coordinates, sales volume metrics and margin value calculations to determine which units (e.g. categories and/or SKUs) should be allocated to particular areas (e.g. spatial coordinates) in a three dimensional space to make the best and most efficient use (e.g. highest margin value) of the volume assigned to a category and/or SKU.

In some example embodiments, the three dimensional optimization system 104 may comprise a store management engine 108, a virtual store generator 110 and/or a virtual store optimization engine 120. The store management engine 108 is configured to access or otherwise activate the virtual store generator 110 to enable a user or operator to generate a model of a three dimensional space and then optimize the three dimensional space based on one or more optimizations as defined by the virtual store optimization engine 120. The store management engine 108 may further be configured to ingest trading data, such as the reference data 132, the performance data 134 and/or the aggregation data 136. Trading data may include but is not limited to data mapped over days, weeks, months, years and/or other periods of time as defined by the store management engine 108.

In some example embodiments, the reference data 132 may include, but is not limited to, SKU identifying information, available SKUs, location information, shipping cost data, cost per SKU data, customer metric data, economic data, trend data, calendar data, weather data, consumer influence data and/or the like. In some example embodiments, the performance data 134 includes, but is not limited to historical sales data, real time sales data (e.g. from point of sale system), projection data, current margin data and/or other data related to the sales of a product or category. In some example embodiments, aggregation data 136 may include, but is not limited to data received from one or more other three dimensional spaces (e.g. other related retailers) such as historical sales data, real time sales data (e.g. from point of sale system), projection data, current margin data and/or other data related to the sales of a product or category.

In some example embodiments, the virtual store generator 110 is configured to enable a user, operator or the like to provide the characteristics of a three dimensional space to the virtual store generator 110 (e.g. draw your three dimensional space). The characteristics of the three dimensional space may include, but are not limited to structural information (e.g. walls, shelving, services and/or the like), unit information (e.g. available SKU's, SKU assignments in categories and/or the like), store preferences, display facing area and/or the like. The characteristics may be entered via a user interface, such as via a computer aided design program, may be ingested from a stocking program or inventory log, or may otherwise be provided or determined via other users and/or systems. In some examples, the store layout engine 112 is configured to generate a model based on the entered details. The model is configured to be representative of a current layout of the three dimensional space. The store layout engine 112 may further be configured to generate an updated or second model in an instance in which one or more optimizations are applied.

In some examples, location attributes may also be defined by the store layout engine 112 for each selling location in a three dimensional space. Each selling location may be identified by an ID, a type (e.g. specialized location) a height, a width, coordinates and special instructions. Each product (e.g. SKU) to be placed in each selling location may also be captured by the virtual store generator 110, such as by an ID, a name, a category, a selling location ID, a height, a width, coordinates, product minimums to be displayed and product maximums, restrictions on locations for the product and/or other instructions (e.g. ignore during optimization or the like). Each category may be defined by attributes, such as category minimums and category maximums.

The SKU/category locator 114 is configured to determine an allocated volume and/or spatial area that may be assigned to each category and/or SKU. For example, the SKU/category locator 114 may be configured to determine the spatial area or volume consumed by the category “soups” and then may further define the spatial area or volume consumed by sub categories or SKUs within the soup category. The SKU/category locator 114 is further configured to determine the spatial area or volume that is occupied by a category and/or SKU as a result of one or more optimizations.

In some example embodiments, the virtual store generator 110, the SKU/category locator 114 or the like is further configured to input, assign or otherwise determine an ID, a name and description for each product and category. For each product, a category may be assigned. Each product may further be defined in terms of a price and/or a retailers cost and, as such, a margin may be determined. Additionally, a minimum product display facing height and width may be determined in terms of measurements or in terms of defined grid dimensions. Other rules for display and/or organization of the one or more products may also be included in some example embodiments.

In some example embodiments, the virtual store optimization engine 120 is configured to arrange, allocate or otherwise assign a volume (e.g. display facing area in some example embodiments) to a category and/or a SKU based in terms of the margin value that the volume occupied by the category and/or SKU is contributing to the overall profitability or margin value of the three dimensional space. Alternatively or additionally, the virtual store optimization engine 120 may be configured to arrange, allocate or otherwise assign an to a category and/or a SKU based in terms of the margin value that the area occupied by the category and/or SKU is contributing to the overall profitability or margin value of a two dimensional space or other multi-dimensional space (e.g. print media, webpage, virtual environment, store, and/or the like).

The virtual store optimization engine may include, but is not limited to, an optimization library 122 and/or a forecasting engine 124. In some examples embodiments, the virtual store optimization engine 120 may be configured to apply one or more optimizations, such as those optimizations in the optimization library 122 to the model generated by the virtual store generator 110. The optimization library 122 may include example optimizations that are configured for optimizing a volume occupied by a plurality of categories or a plurality of SKUs, optimizing the placement of the plurality of categories or the plurality of SKUs and/or optimizing an interdependency between the plurality of categories and/or the plurality of SKUs. In some examples the optimization library may further comprise a floor space optimization that considers weight space compliance, customer centric optimizations based on shopper paths and/or the like. Alternatively or additionally, a combination of the optimizations in the optimization library 122, alternate optimizations and/or the like may be applied in some example embodiments.

In an instance in which the virtual store optimization engine 120 is activated, such as via a user interface, the virtual store optimization engine 120 may be configured to determine one or more categories to include in a three dimensional layout, such as by invoking the optimization library 122. The virtual store optimization engine 120 may then assign spatial coordinates to a category in the three dimensional space, such as via the virtual store generator 110 based on the one or more optimizations. The virtual store optimization engine 120 may consider the one or more optimizations available in the optimization library, along with, but not limited to, the characteristics of the three dimensional space (e.g. frozen items, refrigerated items, height or the like), historical and/or potential contribution to margin value, complementary category dynamics (e.g. batteries next to toys), utility (e.g. prescription lines in a back corner of the three dimensional space, checkout by the door or the like), customer flow patterns, restocking metrics (e.g. distance, weight, volume of restocking or the like) and/or the like.

The virtual store optimization engine 120 may then generate an optimized layout in conjunction with the virtual store generator 110. The optimized layout is configured to assign a spatial area to each category and to the plurality of SKUs based on the one or more applied optimizations. In some example embodiments, the optimized layout may result in increased volume of the three dimensional space that contributes to margin value when compared to a current layout. Alternatively or additionally, the optimized layout may represent a layout that has the greatest volume of categories and/or SKUs that contribute to margin value when compared to other layouts.

The optimization library 122 further comprises one or more optimizations that are configured to cause a certain result if executed. For example, an optimization may be directed to an increase in margin value, a decrease in cost of goods sold, an increase in sales volume, a decrease in stocking costs and/or the like. In some example embodiments, an optimized layout may result from the execution of a category placement optimization. A category placement optimization, in some example embodiments, may include, but is not limited to a floor plan optimization model that is configured to provide weight space compliance and a customer centric algorithm based on historical data sets configured to trace cluster paths of shoppers in a grocery context.

In some example embodiments and by using the characteristics of the three dimensional space including, but not limited to, walls, column breaks and lines to denote shelves, an initial optimized category layout may be generated by the virtual store optimization engine 120 based on the volumetric determinants of a given category, as built up from the total SKU allocation and individual SKU dimension, with weighting for packaging, demarcation or the like. In some examples, the initial layout may be superseded by the user's definition of category placement within the available three dimensional space, based other optimizations, other trading data or the like.

In some examples, the virtual store optimization engine 120 may be configured to blend the physical requirements of space allocation with customer behavior data relating to how customers move through a given three dimensional space, and what category associations might increase sales by revenue or margin metrics. The virtual store optimization engine 120 may undertake an optimization scenario such as, but not limited to (OC×=UC×S/AC×M Where OC is Optimized by Category; UC×S is Units from Category×Sold; and AC×UM is Average Category×Unit Margin).

In some example embodiments, margin contribution across a total available display area that is subject to product placement requirements and demand forecasts may be optimized using the one or more methods described herein. In some examples, a profit contribution per standardized unit of display space (e.g. margin as a function of volume) for each product may be determined that is configured to deliver a result that constrains against a forecasted effective maximum level of sales of the product/category, and/or allows all products to be displayed. Various rules may also be applied to determine particular display unit constraints as well as optimized view placement coordinate parameters, in some example embodiments. One such optimization may include or otherwise may be represented as:

$$Maximise {\sum }_{j = 1}^{n} {\sum }_{i = 1}^{m} {P}_{ij} {A}_{ij}$$

$$subject to {\sum }_{i = 1}^{m} {A}_{ij} = {A}_{j} ; j = 1 , 2 , … , n$$

$${A}_{ij} \geq {A}_{j}^{min} ; j = 1 , 2 , … , n$$

$${A}_{ij} \leq {A}_{ij}^{max} + 2 σ ; j = 1 , 2 , … , n ( {A}_{max} = {f}^{- 1} ( {d}_{ij} + 2 σ ) )$$

Where σ is a standard deviation of sales for product i of category j and where

$${P}_{ij} = \frac{\begin{matrix}total profit for a given period \\ ( wkly ) for product {P}_{i} in category j\end{matrix}}{Current display area units allocated for the product}$$

is profit margin contribution per unit display area. Alternatively or additionally, profit margin contribution per unit display area may also be determined as equal to profit margin per product*(product display space/display unit space). In some examples and with references to the formula above, Aᵢⱼ^{min} is the minimum display area to be allocated for product (e.g. SKU) Pᵢⱼ. Minimum display area may include the product display size, but also may include a display style factor based on the category (e.g. display factor for shirts is lower than for hard goods) in some example embodiments. Aᵢⱼ^{max} is the maximum area to be allocated to a product. Aᵢⱼ^{max} may be derived from the relationship dᵢⱼ₊2σ=f (Aₘₐₓ), where dᵢⱼ is the demand forecast for the considered period (e.g. annual weekly sales) and σ is the standard deviation of sales volumes of product P_{ij,} for a given period (e.g. annual weekly sales). In some examples, the maximum constraints on product sales may then be related to a relationship between products display space/display unit space to determine the maximum area of display space per product (e.g. SKU). Further constraints may exist with respect to display areas with specialized characteristics (e.g. particular size or shape, coffee dispensers, refrigerated or the like).

In some example embodiments, a category may span multiple noncontiguous locations. In such cases, the virtual store optimization engine 120 may further be configured to sum all space within a category as part of a total category display area. Then assign products to the space based on the one or more optimizations and/or restrictions.

The optimized layout may then be rendered in a visualization that identifies, via the user interface, the various placements of the included categories and SKUs in four dimensions. As such, the user, operator or the like may alter, interact with or otherwise utilize the visualization. In some examples, the optimized three dimensional layout may be configured to operate as a dynamic planogram for the stocking of the three dimensional space for a particular time period identified (e.g. four dimensions). For example, the recommend visualization may only be valid for a particular weekend, event, time period or the like. Alternatively or additionally, the optimization may further display rules relating to the layout and/or display space allocation.

In some example embodiments, the forecasting engine 124 is configured to generate real time or near real time recommendations that may result in altering of the optimized three dimensional layout. In some cases, the spatial area or volume allocated to a category or SKU may be altered based on a number of factors, such as, but not limited to increased buying cost, shortages, stocking concerns, customer complaints, marketing, weather, economic factors or the like.

In some example embodiments, the forecasting engine 124 may receive one or more inputs or scenarios from the user. Based on the input scenario, the forecasting engine may be configured to estimate future sales and margin values. For example, weather changes may result in weather related products having a high volume of sales and contributing positively to margin. Further examples may include holiday weekends leading to more potato chips and soda on end caps. The forecasting engine 124 may cause the real time or near real time recommendations to be provided graphically, such as in a user interface. The visualization preferably enables the use of a visualization to function as a guide for a user performing the layout of the units in the physical three dimensional space. Alternatively or additionally, the recommendations provided by the forecasting engine 124 may be for a particular time period, for a particular sale period, and/or the like.

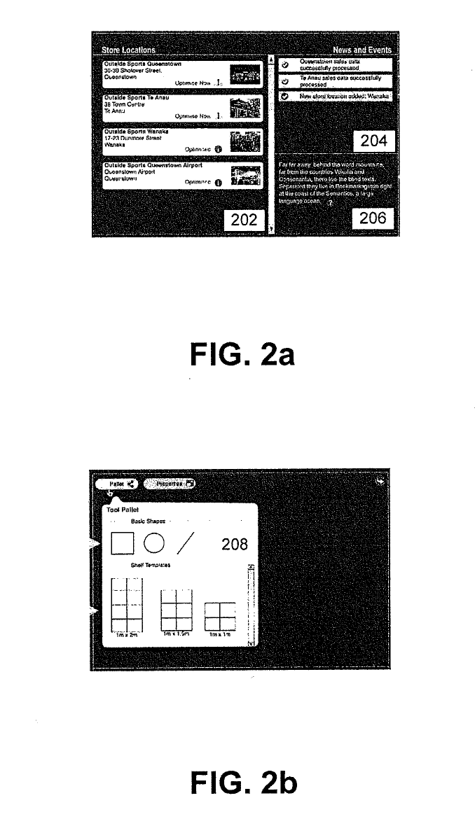

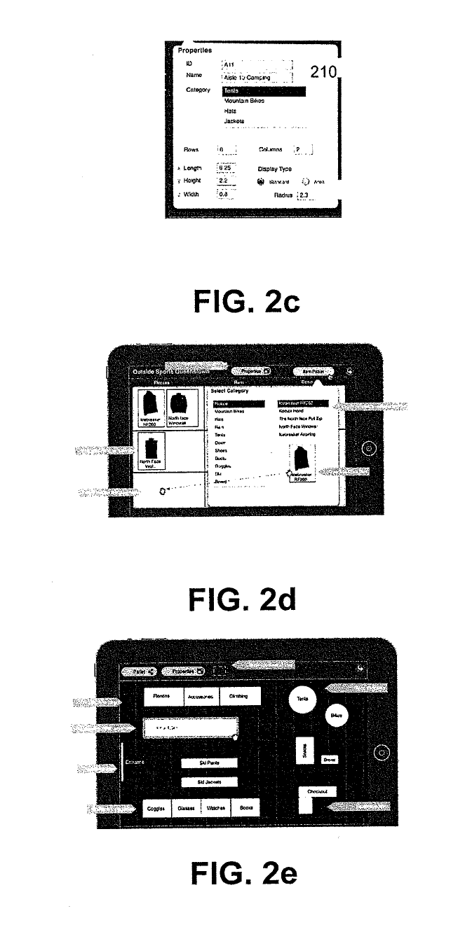

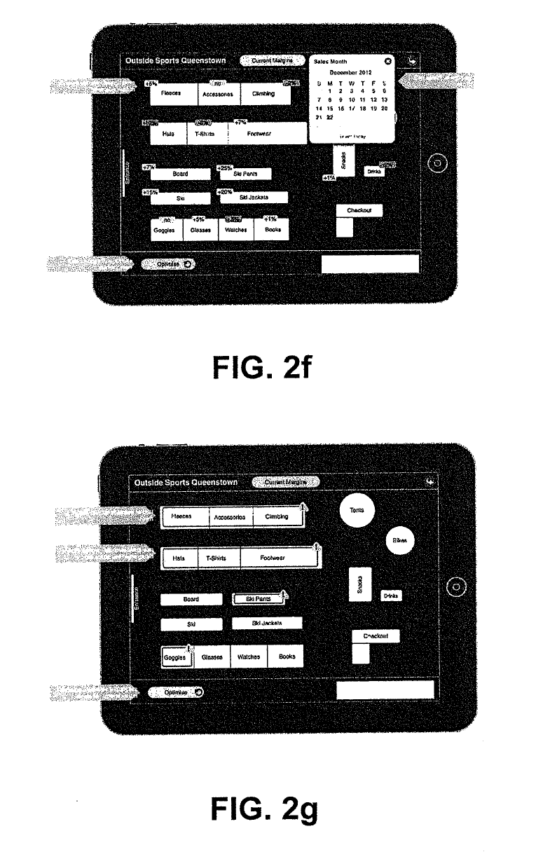

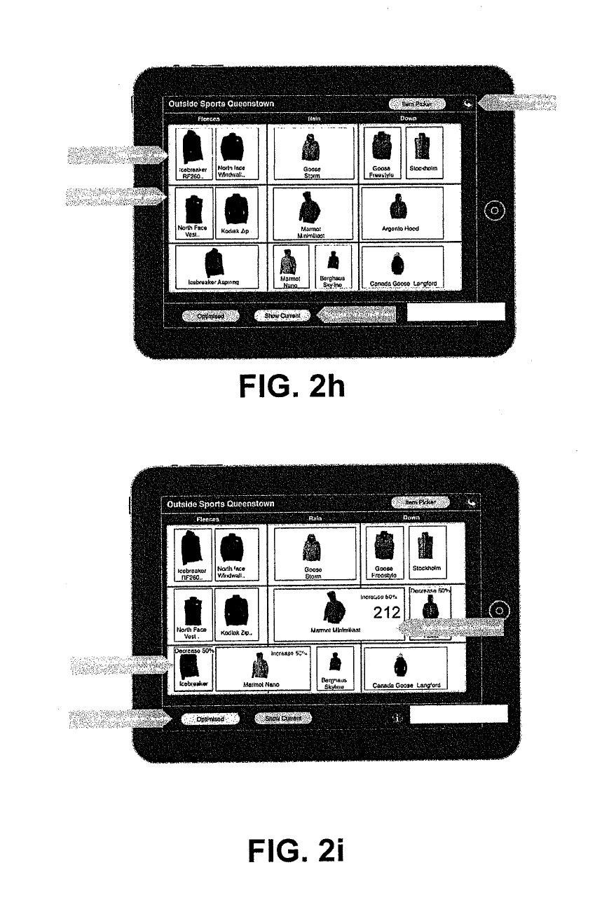

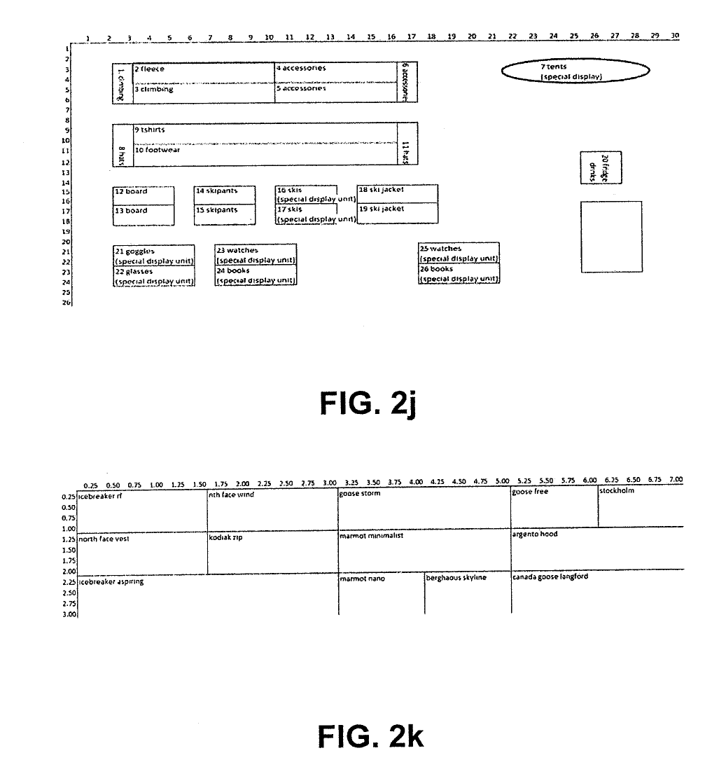

FIGS. 2a-i illustrate a plurality of screen shots of a three dimensional space optimization system in accordance with some example embodiments of the present invention. FIG. 2a illustrates an example landing screen or home screen. FIG. 2a comprises an interface area 202 that is configured to provide a list of three dimensional spaces, such as store locations that may or may not be configured to be optimized using the systems and methods described herein. For each of the three dimensional spaces displayed in interface area 202, an indication may be provided that demonstrates whether a three dimensional space is currently optimized. A store may not be optimized, in some examples, in instance in which the store has never have been optimized or additional news or events, such as the news and events shown in the news and events interface area 204, may have caused a three dimensional space to no longer be optimized. For example, new sales data may indicate or otherwise suggest that a store is no longer optimized. In some cases, forecasting data may be used to determine whether a store is optimized for an upcoming time period.

The news and events interface area 204 may indicate the receipt and processing of additional sales data, new locations, new alerts and/or the like. Interface area 206 may provide reporting, such as sale trends and/or the like. For example, interface area 206 may indicate a storm approaching and suggest expanding an umbrella display in the three dimensional space. Interface areas 204 and 206 may include text that describes or otherwise summarizes the data received.

In some examples, a user may provide an initial layout, a current layout or a description of the three dimensional space via a user interface. FIG. 2b illustrates a portion of a “draw your three dimensional space” functionality in accordance with some example embodiments of the present invention. As is shown in pallet interface area 208, tools may be provided to a user, such as basic shapes, shelf templates and/or other drawing tools, to draw a current layout of a three dimensional space. The user in some example embodiments may place aisles, areas, end caps, aisle displays, shelving units or the like within the three dimensional layout using the user interface illustrated in FIG. 2b.

Once the three dimensional layout is described in terms of characteristics or structures, the user may be enabled or otherwise permitted to assign properties to each of the various characteristics. FIG. 2c illustrates an additional portion of a draw your three dimensional space functionality in accordance with some example embodiments of the present invention and includes a properties interface area 210. The properties interface area 210 is configured to enable a user to represent the measurements and available area consumed by the various structures of the three dimensional space. The properties interface area 210 may include, but is not limited to, an identification assigned to a particular structure, such as an aisle, a name of a structure, a category of product to be assigned to the structure, the number of rows and columns that are defined in the structure (e.g. shelf layout), the overall dimensions of the structure, an occupied floor area for the structure or the like. Once the structure or characteristics of a three dimensional space are provided, the user may further be configured or otherwise permitted to place SKUs within the layout as is shown with reference to FIG. 2d.

FIG. 2e illustrates a three dimensional space floor planner in accordance with some example embodiments of the present invention. The user interface provided with respect to FIG. 2e is configured to provide a bird's eye view of the three dimensional space and enables various display areas and/or aisles to be defined and/or otherwise dimensioned in some example embodiments. Further, as each area or aisle is defined within the three dimensional space, the pallet and properties of FIGS. 2b and 2c may be used to further define the characteristics of each of the areas or aisles in the three dimensional space.

In some example embodiments, upon receipt of a three dimensional space layout, a margin value may be calculated as a function of volume for the categories and/or SKUs available to be placed in the three dimensional space over a particular time period. FIG. 2f illustrates sales data, in particular margin value data, that is overlaid on a layout of the three dimensional space for a selected time period in accordance with some example embodiments of the current invention. As is shown in FIG. 2f, sales data may also be shown in terms of percent change from a previous time period, such as is shown with respect to the fleece aisle or area outlined in FIG. 2f. In this example, the fleece area or aisles indicates a margin increase of 5% over the past month. In this current margin view, as shown with reference to FIG. 2f, a user may therefore optimize using one or more optimizations described herein.

Once the three dimensional space is optimized using one or more optimizations, such as by using one or more of the optimizations described with reference to the optimization library 122 of FIG. 1, one or more categories or areas in the three dimensional space may be highlighted or otherwise be configured to indicate that optimization (e.g. optimization indication) is available, suggested and/or possible in the physical three dimensional space as is shown with reference to FIG. 2g. As is shown with reference to FIG. 2g, the fleece aisle or area may be optimized.

In some example embodiments, the fleece aisle or area that is indicated as needing optimization may be selected by the user. In response to the selection, a user interface, such as the user interface displayed in FIG. 2h, is configured to provide a view of the current layout of aisle or area. In other words, the user interface of FIG. 2h is configured to visually represent the current layout of the physical three dimensional space as well as a recommended optimized layout in response to a user request.

FIG. 2i illustrates an optimized view of a category, aisle or area in accordance with some example embodiments of the current invention. FIG. 2i further defines an interface area 212 that is configured to indicate one or more SKUs that are to gain and/or lose volume on the shelf. As is shown in interface area 212 a particular SKU is recommended to be increased by 50% (e.g. the volume assigned to a SKU is to be increased by 50%) to enable an optimized layout. Other proposed layout changes (e.g. an optimized layout) are displayed visually in FIG. 2i. FIG. 2i is advantageously, for example, configured to provide a view of the preferred layout (e.g. planogram) for a user that is tasked with stocking the optimized area or aisle of the physical three dimensional space.

FIGS. 2j and 2k show a sample layout based on a grid representative of a three dimensional space. FIG. 2j illustrates the layout of a three dimensional space based on categories and/or business units. FIG. 2k illustrates a display facing view showing the location of products (e.g. fleeces) and the display facing. In each of FIGS. 2j and 2k the SKUs and/or categories are arranged based on the determined grid area that represents the three dimensional space.

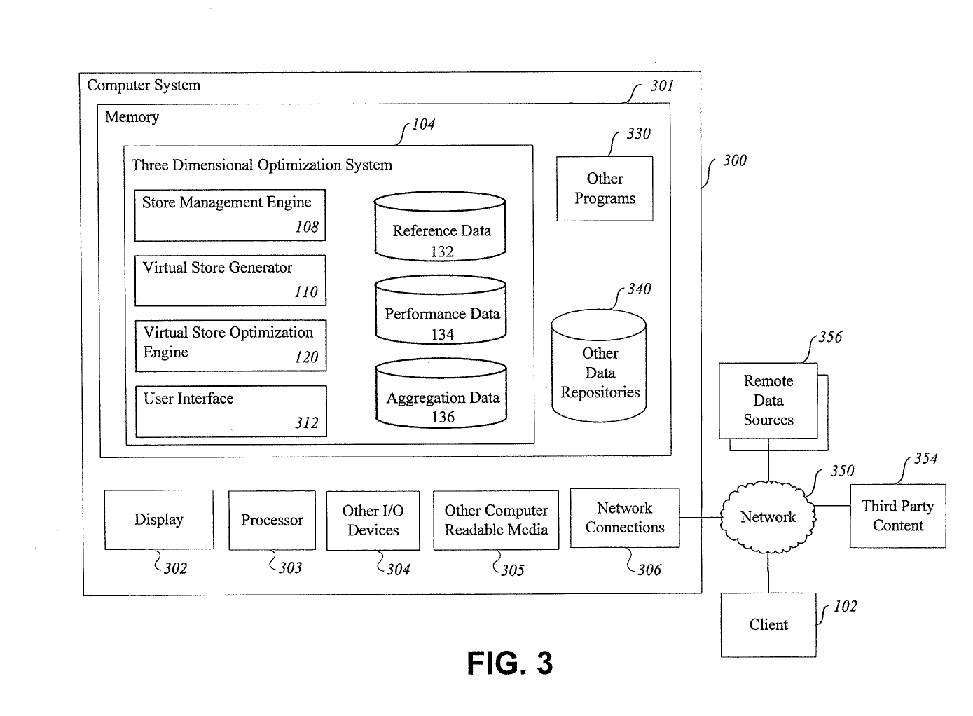

FIG. 3 is an example block diagram of an example computing device for practicing embodiments of a three dimensional space optimization environment. In particular, FIG. 3 shows a computing system 300 that may be utilized to implement a three dimensional optimization system 104. Note that one or more general purpose or special purpose computing systems/devices may be used to implement the three dimensional optimization system 104. In addition, the computing system 300 may comprise one or more distinct computing systems/devices and may span distributed locations. Furthermore, each block shown may represent one or more such blocks as appropriate to a specific embodiment or may be combined with other blocks. Also, the three dimensional optimization system 104 may be implemented in software, hardware, firmware, or in some combination to achieve the capabilities described herein.

In the example embodiment shown, computing system 300 comprises a computer memory (“memory”) 301, a display 302, one or more processors 303, input/output devices 304 (e.g., keyboard, mouse, CRT or LCD display, touch screen and/or the like), other computer-readable media 305, and network connections 306. The three dimensional optimization system 104 is shown residing in memory 301. In other embodiments, some portion of the contents, some or all of the components of the three dimensional optimization system 104 may be stored on and/or transmitted over the other computer-readable media 305. The components of the three dimensional optimization system 104 preferably execute on one or more processors 303 and are configured to optimize a three dimensional space, as described herein. Other code or programs 330 (e.g., an administrative interface, a Web server, and the like) and potentially other data repositories, such as data repository 340, also reside in the memory 301, and preferably execute on one or more processors 303. Of note, one or more of the components in FIG. 3 may not be present in any specific implementation. For example, some embodiments may not provide other computer readable media 305 or a display 302.

In a typical embodiment, as described above, the three dimensional optimization system 104 includes a store management engine 108, a virtual store generator 110, a virtual store optimization engine 120, and/or a user interface 312. In some example embodiments, the three dimensional optimization system 104 may also include or otherwise be in data communication with reference data 132, performance data 134 and/or aggregation data 136. The three dimensional optimization system 104 performs functions such as those described with reference to FIG. 1.

The three dimensional optimization system 104 interacts via the network 350 with remote data sources 356 (e.g. remote reference data, remote performance data, remote aggregation data and/or the like), third-party content providers 354 and/or client devices 102. The network 350 may be any combination of media (e.g., twisted pair, coaxial, fiber optic, radio frequency), hardware (e.g., routers, switches, repeaters, transceivers), and protocols (e.g., TCP/IP, UDP, Ethernet, Wi-Fi, WiMAX) that facilitate communication between remotely situated humans and/or devices. The client devices 102 include desktop computing systems, notebook computers, mobile phones, smart phones, personal digital assistants, tablets and/or the like.

In an example embodiment, components/modules of the three dimensional optimization system 104 are implemented using standard programming techniques. For example, the three dimensional optimization system 104 may be implemented as a “native” executable running on the processor 303, along with one or more static or dynamic libraries. In other embodiments, the three dimensional optimization system 104 may be implemented as instructions processed by a virtual machine that executes as one of the other programs 330. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use synchronous or asynchronous client-server computing techniques. Also, the various components may be implemented using more monolithic programming techniques, for example, as an executable running on a single processor computer system, or alternatively decomposed using a variety of structuring techniques known in the art, including but not limited to, multiprogramming, multithreading, client-server, or peer-to-peer, running on one or more computer systems each having one or more processors. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the three dimensional optimization system 104, such as by using one or more application programming interfaces can be made available by mechanisms such as through C, C++, C#, and Java APIs; libraries for accessing files, databases, or other data repositories; through scripting languages such as XML; or through Web servers, FTP servers, or other types of servers providing access to stored data. The reference data 132, the performance data 134 and/or the aggregation data 136 may be implemented as one or more database systems, file systems, or any other technique for storing such information, or any combination of the above, including implementations using distributed computing techniques. Alternatively or additionally, the reference data 132, the performance data 134 and/or the aggregation data 136 may be local data stores but may also be configured to access data from the remote data sources 356.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in some embodiments, some or all of the components of the three dimensional optimization system 104 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

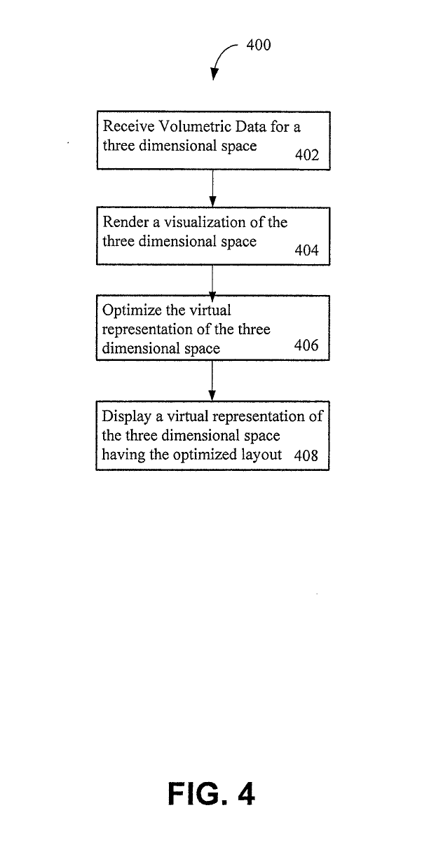

FIGS. 4-16 illustrate example flowcharts of the operations performed by an apparatus, such as computing system 300 of FIG. 3, in accordance with example embodiments of the present invention. It will be understood that each block of the flowcharts, and combinations of blocks in the flowcharts, may be implemented by various means, such as hardware, firmware, one or more processors, circuitry and/or other devices associated with execution of software including one or more computer program instructions. For example, one or more of the procedures described above may be embodied by computer program instructions. In this regard, the computer program instructions which embody the procedures described above may be stored by a memory 301 of an apparatus employing an embodiment of the present invention and executed by a processor 303 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowcharts' block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowcharts' block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts' block(s). As such, the operations of FIGS. 4-16, when executed, convert a computer or processing circuitry into a particular machine configured to perform an example embodiment of the present invention. Accordingly, the operations of FIGS. 4-16 define an algorithm for configuring a computer or processor, to perform an example embodiment. In some cases, a general purpose computer may be provided with an instance of the processor which performs the algorithm of FIGS. 4-16 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowcharts', and combinations of blocks in the flowchart, can be implemented by special purpose hardware-based computer systems which perform the specified functions, or combinations of special purpose hardware and computer instructions.

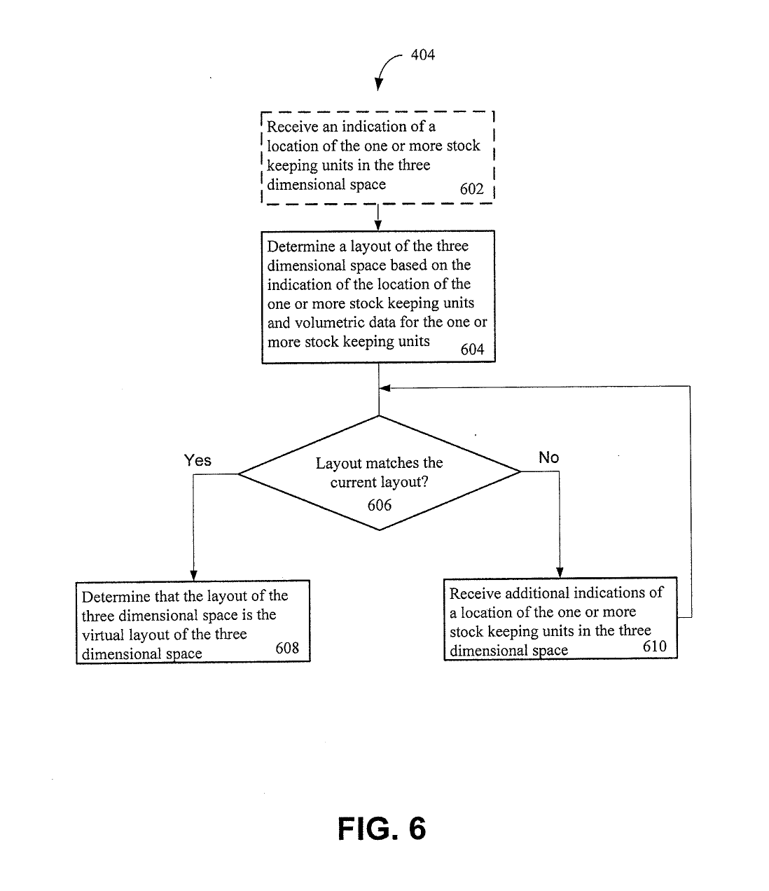

In some example embodiments, certain ones of the operations herein may be modified or further amplified as described below. Moreover, in some embodiments additional optional operations may also be included (some examples of which are shown in dashed lines in FIG. 6). It should be appreciated that each of the modifications, optional additions or amplifications described herein may be included with the operations herein either alone or in combination with any others among the features described herein.

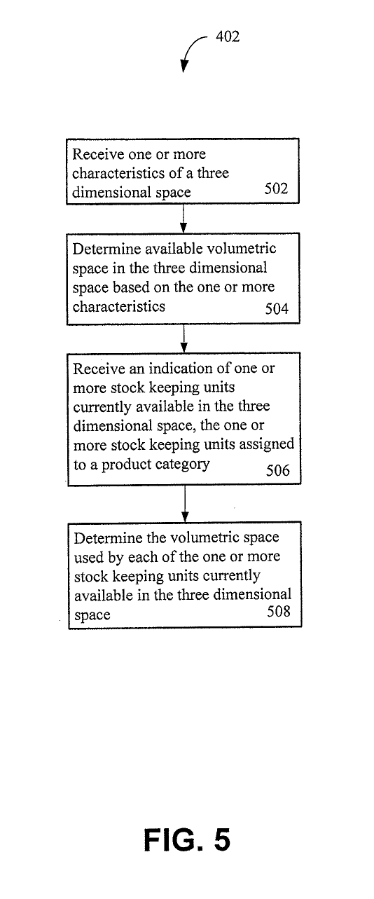

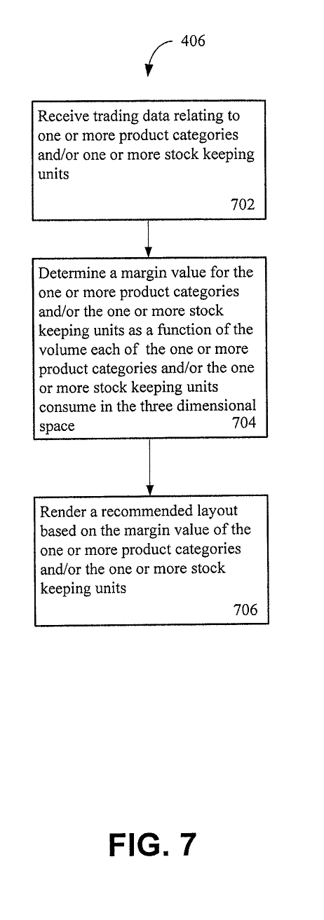

FIG. 4 is a flow chart illustrating an example method 400 for optimizing a three dimensional space. As is shown in operation 402, an apparatus embodied, for example, by a three dimensional optimization system 104, may include means, such as the virtual store generator 110, the processor 303, the user interface 312 or the like, for receiving volumetric data for a three dimensional space. Example methods for receiving volumetric data for a three dimensional space are further described with reference to FIG. 5. As is shown in operation 404, an apparatus embodied, for example, by a three dimensional optimization system 104, may include means, such as the virtual store generator 110, the store layout engine 112, the processor 303, the user interface 312 or the like, for rendering a visualization of the three dimensional space. Example methods for rendering a visualization of the three dimensional space are further described with reference to FIG. 6. As is shown in operation 406, an apparatus embodied, for example, by a three dimensional optimization system 104, may include means, such as the virtual store optimization engine 120, the processor 303 or the like, for optimizing the virtual representation of the three dimensional space. Example methods for optimizing the virtual representation of the three dimensional space are further described with reference to FIG. 7. As is shown in operation 408, an apparatus embodied, for example, by a three dimensional optimization system 104, may include means, such as the store management engine 108, the virtual store generator 110, the processor 303, the user interface 312 or the like, for displaying a virtual representation of the three dimensional space having the optimized layout.

FIG. 5 is a flowchart illustrating an example method 402 for receiving volumetric data for a three dimensional space. As is shown in operation 502, an apparatus embodied, for example, by a three dimensional optimization system 104, may include means, such as the virtual store generator 110, the store layout engine 112, the processor 303, the user interface 312 or the like, for receiving one or more characteristics of a three dimensional space. In some example embodiments, the characteristics may include, but are not limited to, layout, shelf design, structural design and/or the other physical parameters that define the three dimensional space. In some example embodiments, the characteristics may be entered using one or more space design templates in a user interface 312, the characteristics may also be entered via measurements, images, video, global positioning system tracking, a computer aided design, blueprints, and/or the like. See also for example FIGS. 2b-2e.

As is shown in operation 504, an apparatus embodied, for example, by a three dimensional optimization system 104, may include means, such as the virtual store generator 110, the processor 303, the user interface 312 or the like, for determining available volumetric space in the three dimensional space based on the one or more characteristics (e.g. structures). In some example embodiments, the virtual store generator 110 is configured to determine the available space (e.g. space that is configured to display a SKU) and is further configured to determine the character and/or restrictions of a given space. The characteristics may include, for example, areas that are wired for coolers or freezers, areas that are dedicated to a florist, butcher, and/or the like. Other structural information may include determining height restrictions, distances to and from a loading bay or warehouse, weight restrictions, health code restrictions and/or the like. Alternatively or additionally, the volumetric characteristics may be variable in some locations based on the ability to move, arrange or otherwise alter shelf space, shelf height and/or shelf quantity.

As is shown in operation 506, an apparatus embodied, for example, by a three dimensional optimization system 104, may include means, such as the virtual store generator 110, the SKU/category locator 114, the processor 303, the user interface 312 or the like, for receiving an indication of one or more SKUs currently available in the three dimensional space. SKU information, category information or other variable information may be received prior to, concurrent with or after receiving the characteristics of the three dimensional space. In some example embodiments, one or more SKUs may be assigned to a single product category, although such an assignment is not required in all example embodiments. The SKUs or product categories may be input via the user interface and/or generated by the store management engine 108 via the reference data 132, the performance data 134 and/or the aggregation data 136.

As is shown in operation 508, an apparatus embodied, for example, by a three dimensional optimization system 104, may include means, such as the virtual store generator 110, the SKU/category locator 114, the processor 303, the user interface 312 or the like, for determining a volumetric space occupied by each of the one or more stock keeping units currently available in the three dimensional space. For example, for each SKU, group of related SKUs and/or categories, a volumetric space may be determined and/or otherwise assigned.

FIG. 6 is a flowchart illustrating an example method 404 for rendering a visualization of the three dimensional space. As is shown in operation 602, an apparatus embodied, for example, by a three dimensional optimization system 104, may include means, such as the virtual store generator 110, the SKU/category locator 114, the processor 303, or the like, for receiving an indication of a location of one or more stock keeping units in the three dimensional space. In some example embodiments, a user may enter a current layout of the three dimensional store that indicates both the characteristics of the three dimensional space as well as the location of one or more SKUs and/or categories within the three dimensional space. The indication of a location of the one or more stock keeping units may additionally provide an indication of a quantity and/or a volume currently occupied by the one or more SKUs and/or categories within the three dimensional space. Alternatively or additionally, a listing of SKUs currently being offered in the three dimensional space may be determined or otherwise generated based on the reference data 132, performance data 134 and/or aggregation data 136.

As is shown in operation 604, an apparatus embodied, for example, by a three dimensional optimization system 104, may include means, such as the virtual store generator 110, the store layout engine 112, the processor 303, or the like, for determining a layout of the three dimensional space based on the indication of the location of the one or more stock keeping units and volumetric data for the one or more stock keeping units. In some example embodiments, the virtual store generator 110, may generate the layout based on the characteristics of the three dimensional space and the indication of the location of the one or more stock keeping units, however in alternate embodiments a user may provide, such as via the user interface 312, the actual layout of the three dimensional space. See e.g. FIGS. 2b-2e. Alternatively or additionally, a generic layout may be determined by the virtual store generator 110 based on heuristics, other similar stores, recommended product layouts and/or the like.

As is shown in decision operation 606, an apparatus embodied, for example, by a three dimensional optimization system 104, may include means, such as the virtual store generator 110, the processor 303, the user interface 312 or the like, for causing a layout to be displayed via the user interface 312, such that a user may determine whether the determined layout of operation 604 matches the actual or current layout of the three dimensional space. In some example embodiments, the determination may also be made via an image comparison or via other means that are used to describe a configuration of a three dimensional space.

In an instance in which, the layout does not match the current layout, then as is shown in operation 610, an apparatus embodied, for example, by a three dimensional optimization system 104, may include means, such as the virtual store generator 110, the processor 303, the user interface 312 or the like, for receiving additional indications of a location of the one or more stock keeping units in the three dimensional space. For example, a user may rearrange the layout using a user interface 312 and/or the like. In an instance in which, the layout does match the current layout, then as is shown in operation 612, an apparatus embodied, for example, by a three dimensional optimization system 104, may include means, such as the virtual store generator 110, the processor 303, or the like, for determining that the layout of the three dimensional space is the virtual layout of the three dimensional space.

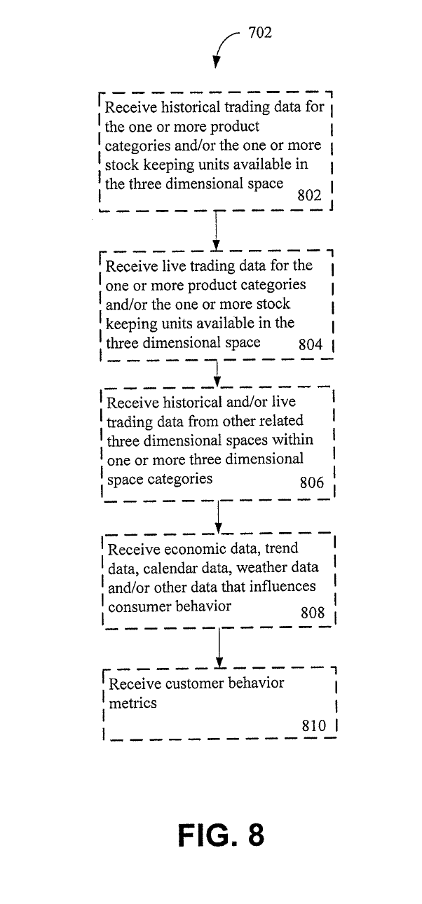

FIG. 7 is a flowchart illustrating an example method 406 for optimizing the virtual representation of the three dimensional space. In some example embodiments, a current layout, a proposed layout and/or a new layout based on available SKUs may optimized based on one or more optimizations. The optimizations may be configured to operate on trading data, such as the data stored within or made accessible by reference data 132, performance data 134 and/or aggregation data 136, the current layout of the three dimensional space and/or the like. As is shown in operation 702, an apparatus embodied, for example, by a three dimensional optimization system 104, may include means, such as the virtual store optimization engine 120, the processor 303 or the like, for receiving trading data relating to one or more product categories and/or one or more stock keeping units. Example methods for receiving trading data relating to one or more product categories and/or one or more stock keeping units are further described with reference to FIG. 8.

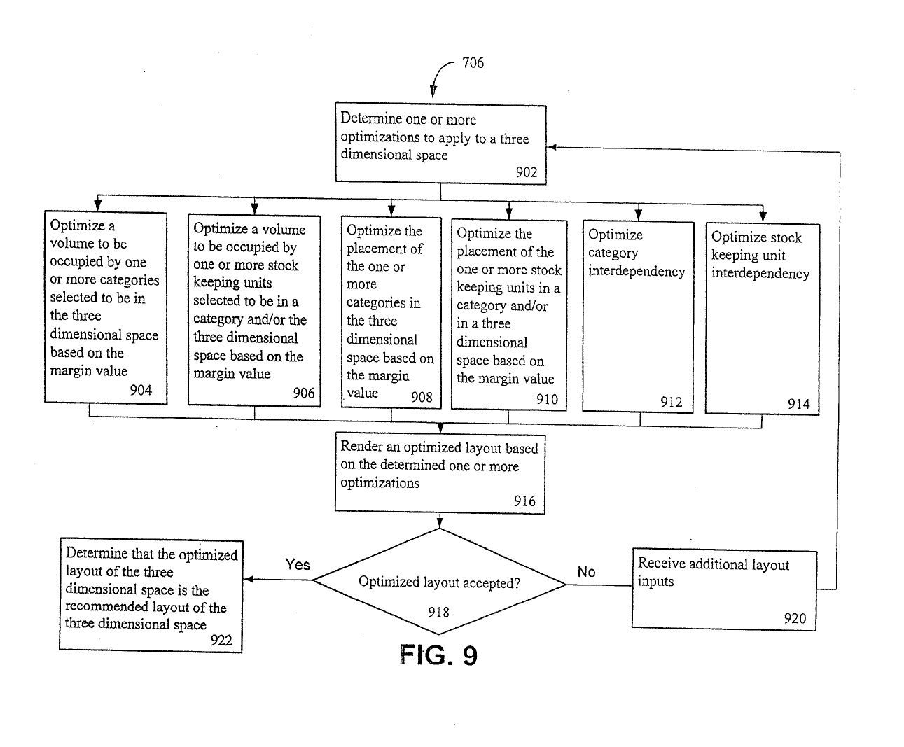

As is shown in operation 704, an apparatus embodied, for example, by a three dimensional optimization system 104, may include means, such as the virtual store optimization engine 120, the processor 303 or the like, for determining a margin value or a change in margin value over a period for the one or more product categories and/or the one or more stock keeping units as a function of the volume each of the one or more product categories and/or the one or more stock keeping units consume in the three dimensional space. In some example embodiments, a margin value may be configured to represent margin per unit of volume for a SKU and/or a product category. The margin for a SKU may be determined based on the trading data received at least in part from the reference data 132, the performance data 134 and/or the aggregation data 136. As is shown in operation 706, an apparatus embodied, for example, by a three dimensional optimization system 104, may include means, such as the virtual store optimization engine 120, the processor 303 or the like, for rendering a recommended layout based on the margin value of the one or more product categories and/or the one or more stock keeping units. Example methods for rendering a recommended layout based on the margin value of the one or more product categories and/or the one or more stock keeping units are further described with reference to FIG. 9.

FIG. 8 is a flowchart illustrating an example method 702 for receiving trading data relating to one or more product categories and/or one or more stock keeping units. In some example embodiments, trading data may be received from one or more sources, including but not limited to, reference data 132, performance data 134 and/or aggregation data 136. Alternatively or additionally, trading data may also include cost of goods sold, SKU costs, current or historical prices, current or historical margins and/or the like. For example, as is shown in operations 802 and/or 804, an apparatus embodied, for example, by a three dimensional optimization system 104, may include means, such as the store management engine 108, the processor 303 or the like, for receiving historical trading data for the one or more product categories and/or the one or more stock keeping units available in the three dimensional space and/or receiving live trading data (e.g. from a point of sale system), for the one or more product categories and/or the one or more stock keeping units available in the three dimensional space. In some example embodiments, live and/or historical trading data may be continuously received and updated, as such in some examples the store management engine 108 may be configured to perform real time or near real time updating and/or data cleansing.

In some example embodiments and as is shown in operation 804, an apparatus embodied, for example, by a three dimensional optimization system 104, may include means, such as the store management engine 108, the processor 303 or the like, for receiving historical and/or live trading data from other related three dimensional spaces within one or more three dimensional space categories. For example, historical and/or live trading data from other three dimensional spaces that deal in the same goods or services. In some examples, the historical and/or live trading data provides an indication of margin value, but is anonymized to protect confidential business information such as pricing data.

In some example embodiments and as is shown in operation 806, an apparatus embodied, for example, by a three dimensional optimization system 104, may include means, such as the store management engine 108, the processor 303 or the like, for receiving economic data, trend data, calendar data, weather data and/or other data that influences consumer behavior. In some examples, data not directly related to price, cost or margin may have a positive and/or negative effect on a margin value. For example, certain weather patterns may increase consumer demand and as such sale prices may be increased resulting in an increased margin value. In other examples, weather patterns may indicate a future shortage of a product and may raise the cost of goods sold resulting in a reduced margin value. Other related data, such as economic data, may be suggestive of customer's propensity to purchase luxury goods versus staples. In each of the examples, additional data may be used to further optimize and/or customize recommendations for the three dimensional space.

In some example embodiments and as is shown in operation 810, an apparatus embodied, for example, by a three dimensional optimization system 104, may include means, such as the store management engine 108, the processor 303 or the like, for receiving customer behavior metrics. Customer behavior metrics may include, but are not limited to, customer purchasing habits, customer shopping path data and/or the like. An example customer behavior metric may indicate that an increase in margin results when bacon is next to eggs or batteries are placed next to toys. Customer behavior data may include data from a current three dimensional space or from other three dimensional spaces that is suggestive of a consumers buying habits. In some examples a manufacturer or other retailer may indicate or otherwise provide customer behavior data.

FIG. 9 is a flowchart illustrating an example method 706 for rendering a recommended layout based on the margin value of the one or more product categories and/or the one or more stock keeping units. As is shown in operation 902, an apparatus embodied, for example, by a three dimensional optimization system 104, may include means, such as the store management engine 108, the virtual store optimization engine 120, the processor 303 or the like, for determining one or more optimizations to apply to a three dimensional space. In some example embodiments, the virtual store optimization engine 120 may comprise and/or otherwise be in data communication with an optimization library 122.

As is described herein, the optimization library 122 may comprise one or more optimizations, such as the optimizations described in operations 904-914. Each of the optimizations, a sub set of optimizations or other optimizations may be invoked in some example embodiments by a user, via a user interface, by the virtual store optimization engine 120 or the like. In some example embodiments, the optimization chosen, for example, the area of a three dimensional space to be optimized, a particular category to be optimized, an interdependency between categories to be optimized and/or the like. A non-limiting set of example optimizations will now be described with respect to operations 904-914.

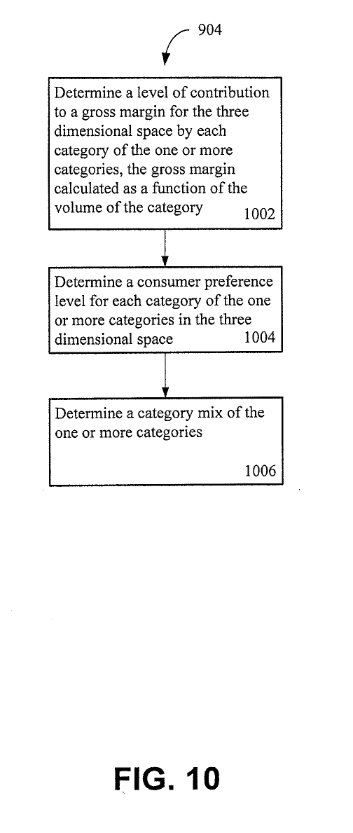

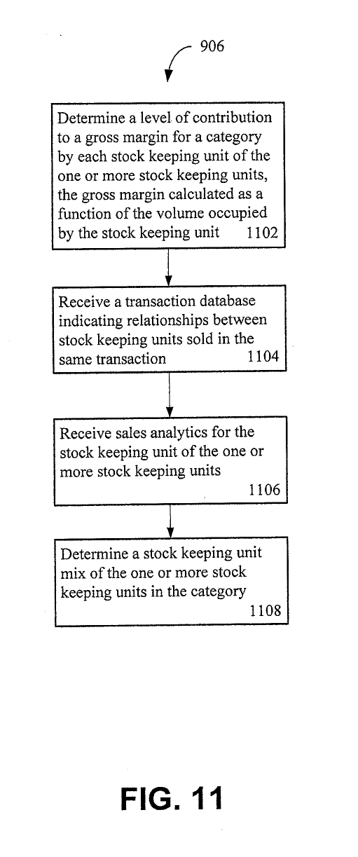

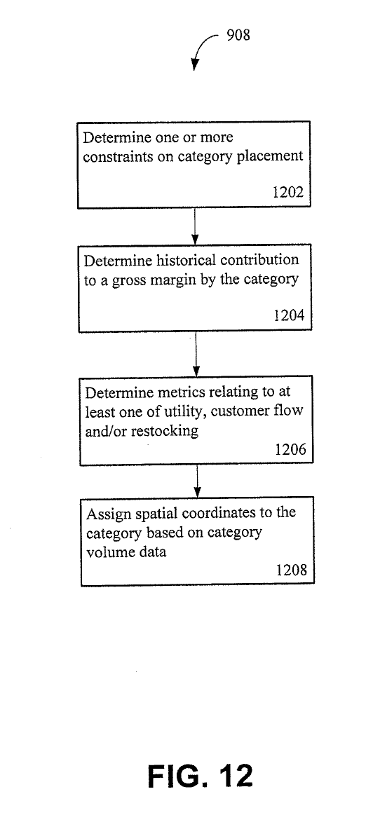

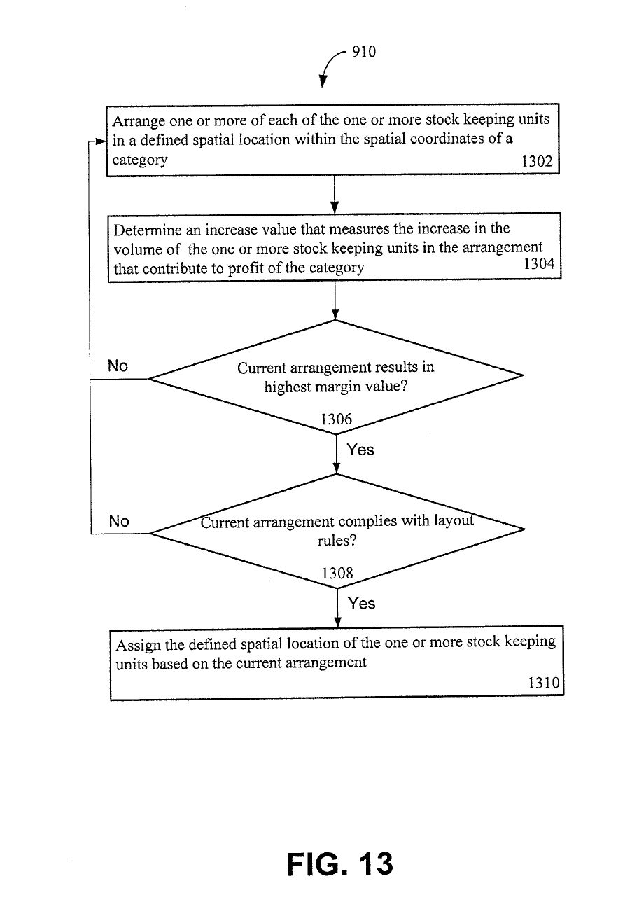

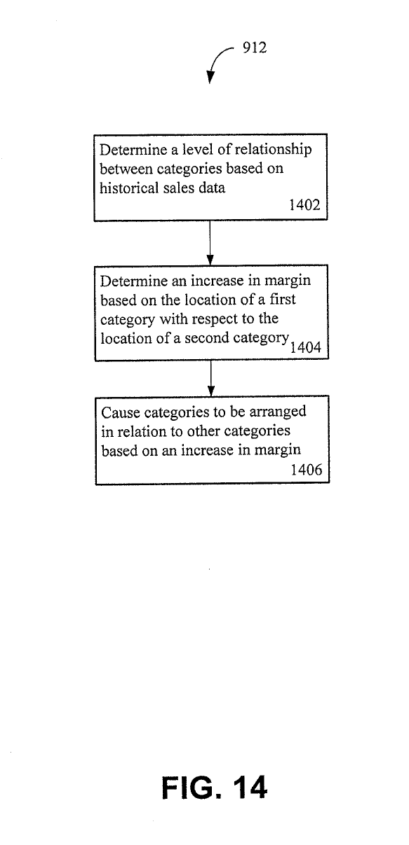

As is shown in operation 904, an apparatus embodied, for example, by a three dimensional optimization system 104, may include means, such as the store management engine 108, the virtual store optimization engine 120, the optimization library 122, the processor 303 or the like, for optimizing a volume to be occupied by one or more categories selected to be in the three dimensional space based on the margin value. Example methods for optimizing a volume to be occupied by one or more categories selected to be in the three dimensional space based on the margin value are further described with reference to FIG. 10. As is shown in operation 906, an apparatus embodied, for example, by a three dimensional optimization system 104, may include means, such as the store management engine 108, the virtual store optimization engine 120, the optimization library 122, the processor 303 or the like, for optimizing a volume to be occupied by one or more stock keeping units selected to be in a category and/or the three dimensional space based on the margin value. Example methods for optimizing a volume to be occupied by one or more stock keeping units selected to be in a category and/or the three dimensional space based on the margin value are further described with reference to FIG. 11. As is shown in operation 908, an apparatus embodied, for example, by a three dimensional optimization system 104, may include means, such as the store management engine 108, the virtual store optimization engine 120, the optimization library 122, the processor 303 or the like, for optimizing the placement of the one or more categories in the three dimensional space based on the margin value. Example methods for optimizing the placement of the one or more categories in the three dimensional space based on the margin value are further described with reference to FIG. 12. As is shown in operation 910, an apparatus embodied, for example, by a three dimensional optimization system 104, may include means, such as the store management engine 108, the virtual store optimization engine 120, the optimization library 122, the processor 303 or the like, for optimizing the placement of the one or more stock keeping units in a category and/or in a three dimensional space based on the margin value. Example methods for optimizing the placement of the one or more stock keeping units in a category and/or in a three dimensional space based on the margin value are further described with reference to FIG. 13. As is shown in operation 912, an apparatus embodied, for example, by a three dimensional optimization system 104, may include means, such as the store management engine 108, the virtual store optimization engine 120, the optimization library 122, the processor 303 or the like, for optimizing category interdependency. Example methods for optimizing category interdependency are further described with reference to FIG. 14. As is shown in operation 914, an apparatus embodied, for example, by a three dimensional optimization system 104, may include means, such as the store management engine 108, the virtual store optimization engine 120, the optimization library 122, the processor 303 or the like, for optimizing stock keeping unit interdependency. Example methods for optimizing stock keeping unit interdependency are further described with reference to FIG. 14.

As is shown in operation 916, an apparatus embodied, for example, by a three dimensional optimization system 104, may include means, such as the store management engine 108, the virtual store optimization engine 120, the processor 303 or the like, for rendering an optimized layout based on the determined one or more optimizations. In some example embodiments, an optimized layout may be based on one or more of the optimizations described with reference to operations 904-914. Other optimizations may be used in different embodiments. The rendering may be generated, by the virtual store generator, based on the one or more characteristics (e.g. structure, structural layout and/or the like) and/or an initial layout of the three dimensional space. In some example embodiments, the rendering may further include recommendations to alter and/or otherwise modify the three dimensional space, such as by changing shelving type, shelving height, organization, adding end caps and/or the like. In some example embodiments, the optimized layout may be rendered on a user interface so as to function as a guide for a user to arrange a physical three dimensional space based on the rendered optimized layout. Alternatively or additionally, the recommended layout may only highlight changes to be made to a current store layout.

In instances in which a layout is rendered for display in a user interface and as is shown in decision operation 918, an apparatus embodied, for example, by a three dimensional optimization system 104, may include means, such as the store management engine 108, the virtual store optimization engine 120, the virtual store generator 110, the processor 303 or the like, for receiving an indication as to whether the optimized layout is accepted. For example, in some examples an optimized layout may not include particular categories or SKUs that the user may require to be in a particular store. By way of further example, in some instances staples such as dairy or meat may have a low margin or a negative margin, however a grocery store without dairy or meat may not attract customers.

As such, in an instance which the optimized layout is not accepted and as is shown in operation 920, an apparatus embodied, for example, by a three dimensional optimization system 104, may include means, such as the store management engine 108, the virtual store optimization engine 120, the virtual store generator 110, the processor 303 or the like, for receiving additional layout inputs. For example, additional data may be received in the form of user selections, user movement of products, SKUs or the like. In some example, embodiments the user may choose alternative optimizations and may restart with operation 902. In other examples, certain quantities or placement of SKUs may be marked as required.

In an instance in which the optimized layout is accepted, then as is shown in operation 922, an apparatus embodied, for example, by a three dimensional optimization system 104, may include means, such as the store management engine 108, the virtual store optimization engine 120, the virtual store generator 110, the processor 303 or the like, for determining that the optimized layout of the three dimensional space becomes the recommended layout of the three dimensional space. In some examples, multiple iterations of optimizations and additional input may be accomplished before the recommend layout is presented.

FIG. 10 is a flowchart illustrating an example method 904 for optimizing a volume to be occupied by one or more categories selected to be in the three dimensional space based on the margin value. In some example embodiments, category selection describes the decision point around the types of products to carry in any given three dimensional space. For example, each user or retailer faces the dilemma of what categories of products to provide in the physical space available. In some cases, a retailer may only focus on a single category, but for other retailers there are a number of decisions to be made as to what categories and how much of a category to stock such that the best returns or margin value may be achieved.

As is shown in operation 1002, an apparatus embodied, for example, by a three dimensional optimization system 104, may include means, such as the store management engine 108, the virtual store optimization engine 120, the optimization library 122, the processor 303 or the like, for determining a level of contribution to a gross margin for the three dimensional space by each category of the one or more categories, the gross margin is calculated as a function of the volume of the category. As is shown in operation 1004, an apparatus embodied, for example, by a three dimensional optimization system 104, may include means, such as the store management engine 108, the virtual store optimization engine 120, the optimization library 122, the processor 303 or the like, for determining a consumer preference level for each category of the one or more categories in the three dimensional space. In some example embodiments, a consumer preference level may be determined based on a consumer's preference for a retailer given the retailers provision of a certain category. Once such consumer preference level may be represented by the following example formula. Based on the determined level of contribution to gross margin and consumer preference level, as is shown in operation 1006, an apparatus embodied, for example, by a three dimensional optimization system 104, may include means, such as the store management engine 108, the virtual store optimization engine 120, the optimization library 122, the processor 303 or the like, for determining a consumer preference level for determining a category mix of the one or more categories.

FIG. 11 is a flowchart illustrating an example method 906 for optimizing a volume to be occupied by one or more stock keeping units selected to be in a category and/or the three dimensional space based on the margin value. In some example embodiments, the SKUs may be selected based on the categories selected with reference to FIG. 10, however in other example embodiments, the SKUs may be selected independently from the categories of FIG. 10. In an instance in which a choice has been made as to the categories to be included, SKUs may be added to those categories to optimize returns for the category. In some cases SKU optimization may include, but is not limited to, units sold per SKU, seasonal volume variation, and/or margin per SKU.

As is shown in operation 1102, an apparatus embodied, for example, by a three dimensional optimization system 104, may include means, such as the store management engine 108, the virtual store optimization engine 120, the optimization library 122, the processor 303 or the like, for determining a level of contribution to a gross margin for a category by each stock keeping unit of the one or more stock keeping units, the gross margin is calculated as a function of the volume occupied by the stock keeping unit. As is shown in operation 1104, an apparatus embodied, for example, by a three dimensional optimization system 104, may include means, such as the store management engine 108, the virtual store optimization engine 120, the optimization library 122, the processor 303 or the like, for receiving a transaction database indicating relationships between stock keeping units sold in the same transaction. The database may also track a historical list of a SKUs position on a shelf as well as various predetermined thresholds.

In some examples the transaction database may be scanned in order to determine which SKUs are in the database and how frequently they occur. In an instance in which a SKU satisfies a predetermined threshold, then that SKU is identified as a 1-s-itemset. Additionally, a tree may be built, such as an AVL tree, to store transaction identifiers of all transactions received, such as via the reference data 132, the performance data 134, and/or the aggregation data 136, containing the SKU.

As is shown in operation 1106, an apparatus embodied, for example, by a three dimensional optimization system 104, may include means, such as the store management engine 108, the virtual store optimization engine 120, the optimization library 122, the processor 303 or the like, for receiving sales analytics for the stock keeping unit of the one or more stock keeping units. As is shown in operation 1108, an apparatus embodied, for example, by a three dimensional optimization system 104, may include means, such as the store management engine 108, the virtual store optimization engine 120, the optimization library 122, the processor 303 or the like, for determining a stock keeping unit mix of the one or more stock keeping units in the category. The stock keeping unit mix may be determined based on a margin value per volume and describes the volume to be occupied by each SKU selected to be in the three dimensional space. In some embodiments, a SKU or a plurality of SKUs may be chosen in order to maximize a margin value.

FIG. 12 is a flowchart illustrating an example method 908 for optimizing the placement of the one or more categories in the three dimensional space based on the margin value. In some example embodiments, once selected for inclusion in the retail space, a category is to be provided with a physical set of spatial coordinates to demarcate it from other categories in the three dimensional space.

As is shown in operation 1202, an apparatus embodied, for example, by a three dimensional optimization system 104, may include means, such as the store management engine 108, the virtual store optimization engine 120, the optimization library 122, the processor 303 or the like, for determining one or more constraints on category placement. Constraints include but are not limited to, those categories that must be place in a certain kind of display (e.g. refrigeration unit or the like), categories that must be included in the store, or the like. As is shown in operation 1204, an apparatus embodied, for example, by a three dimensional optimization system 104, may include means, such as the store management engine 108, the virtual store optimization engine 120, the optimization library 122, the processor 303 or the like, for determining historical contribution to a gross margin by the category such as from the reference data 132, the performance data 134 and/or the aggregation data 136. As is shown in operation 1206, an apparatus embodied, for example, by a three dimensional optimization system 104, may include means, such as the store management engine 108, the virtual store optimization engine 120, the optimization library 122, the processor 303 or the like, for determining metrics relating to at least one of utility (e.g. prescription queuing at the rear of a store), customer flow and re-stocking metrics, and distance to restock. Alternatively or additionally, other example variables that may affect the placement of the category within the three dimensional space include, but are not limited to, physical dimensions (e.g. three dimensional space characteristics) of space allocated to the category (e.g. bulk frozen goods are limited to a freezer section), complementary category dynamics (e.g. batteries next to toys), total SKU allocation, SKU dimensions, SKU weights, demarcation, packaging limitations and/or the like. As such a floor plan optimization model may be constructed to optimize the use of space compliance.

In some example embodiments physical requirements of space allocation may be blended with customer behavior data related to how customers move through a given three dimensional space and further what category associations might increase sales by revenue or margin values. As such, by analyzing customer profiles and behaviors, customers can be segmented into smaller groups. In some example embodiments, an optimization model may be determined, such as by the processor 303, to describe the movement of customers through a three dimensional space.

In some example embodiments and given a data set of c customers that visited ci (x,y) coordinates during their shopping, customers may be placed into predetermined number of clusters and to obtain an assignment of customers that leads to shopping path-based segmentations of categories. For example by determining the total shopping time of that customer and the time spent at each (x, y) coordinates that she/he visited. Since the number of attributes (e.g. stops in the three dimensional space) for each customer varies, each path is defined with the same or similar number of visited (x, y) coordinates. As such each path may be standardized in order to perform pair-wise comparisons. In some example embodiments, the shopping path may include 10 (x,y) coordinates. Other numbers of coordinates may be used, such as 50, 100 or the like in other example embodiments, however, once the number of (x,y) coordinates is determined, the number is configured to be standardized for all paths.

In some example embodiments, the virtual store optimization engine 120, the processor 303 or the like is configured to divide the total shopping time with determined number of (x, y) coordinates. In other words, the location of the customer in the store may be determined at a set time interval, such as every 3 seconds. For example, at the third, sixth, ninth and twelfth seconds the customer is at (2, 4), at the fifteenth second at (3, 4), etc. As such a customer cluster model may be constructed that tracks the path of customers through the three dimensional space.

In some example embodiments, the virtual store optimization engine 120, the processor 303 or the like is configured to combine the floor plan optimization model and the customer path cluster model to determine a placement of categories. As is shown in operation 1208, an apparatus embodied, for example, by a three dimensional optimization system 104, may include means, such as the store management engine 108, the virtual store optimization engine 120, the optimization library 122, the processor 303 or the like, for assigning spatial coordinates to the category based on category volume data.

FIG. 13 is a flowchart illustrating an example method 910 for optimizing the placement of the one or more SKUs in a category and/or in a three dimensional space based on the margin value. In some example embodiments, a SKU may be placed based on its contribution to margin irrespective of a category. However, in other example embodiments, once selected for inclusion and placed in the three dimensional space, a category may be populated with the SKU's that are relevant to category success and those most likely to contribute to margin on a volume per SKU basis. SKU placement may have effects of layout design, SKU interdependency and overall store aesthetic.

As is shown in operation 1302, an apparatus embodied, for example, by a three dimensional optimization system 104, may include means, such as the store management engine 108, the virtual store optimization engine 120, the optimization library 122, the processor 303 or the like, for arranging one or more of each of the one or more stock keeping units in a defined spatial location within the spatial coordinates of a category. As is shown in operation 1304, an apparatus embodied, for example, by a three dimensional optimization system 104, may include means, such as the store management engine 108, the virtual store optimization engine 120, the optimization library 122, the processor 303 or the like, for determining an increase value that measures the increase in the volume of the one or more stock keeping units in the arrangement that contribute to profit of the category. For example, a model may be constructed that represents the margin value for each SKU as placed in the three dimensional model. As such, for the volume of the each SKU chosen to be in the three dimensional space and the location of placement of each of the SKU's the increase value be determined so as to determine the arrangement that results in the greatest margin value while satisfying the SKU placement constraints.

In some example embodiments an example model may be constructed to represent SKU placement. In the example model, the number of SKUs in the market may be denoted by I, the number of observations for SKU i may be denoted by Ti, and the number of item attributes may be denoted by L. Among the L attributes, in some examples there may be C·L shelf characteristics (e.g. characteristics of the three dimensional space) such as the number of facings, the shelf number and the distance to the end of the shelf. In some example trading data, such as sales may be denoted K explanatory variables, such as price and promotion. For example, let In Si/t be the natural log of sales of SKU i at time t=1; : : : ; Ti. The model may then be represented as, in some examples:

In Si;t=X0

i;t−i;t+″i;t; i=1; : : : ; I; t=1; : : : ; Ti (1)

where Xi;t denotes a (K+1) 1 dimensional vector containing, for example, an intercept and the K explanatory variables for SKU i at time t and where i;t=(0;i;t; : : : ; ⁻K;i;t)0 with ⁻k;i;t the coefficient measuring the effect of the k-th explanatory variable for SKU i at time t. The vector of explanatory variables may contain, but are not limited to (log-transformed) marketing instruments such as price, feature and 0/1 dummy variables such as promotion. In some example embodiments, the error term ″i;t may be independently distributed N(0; 3/42i).

In some examples, the parameters in equation (1) may differ across SKUs and/or across time. To describe how these parameters vary over these two dimensions, a second layer may be added to the model to account for marketing-effect parameters. Item-specific attribute data and shelf-layout descriptions may be used as variables to describe a marketing effect. Of these attributes, the shelf characteristics are most likely to change, except in an instance of relocation of items during the observational period. Observed attributes of item i may be denoted by an (L+1) £ 1 vector Zi;t. This example vector may contain an intercept, SKU characteristics, and shelf layout characteristics at a given time t. An example linear relation between the item-specific parameters and the attribute space, may include but is not limited to:

⁻i;t=° Zi;t+′i; ′i [symbol] N(0;§′) (2)

where ° is a (K+1) £ (L+1) matrix of parameters. The coefficients ° k;I represent, in some examples, the effect of attribute I on the effect size of marketing instrument k. For k=0 the coefficients are configured to represent the effects of the SKU characteristics on the intercept of the sales equation. In other words, ° k;I, in some example embodiments, represent the effect of the shelf layout on sales.

In some example embodiments, the joint effect of additional or alternative attributes (e.g. intangibles such as brand equity) may be represented by a distributed disturbance term in equation (2), for example ′i=(′i;0; ′i;1; : : : ; ′i;K)0 [symbol] N(0;§′). In some examples, it may be assume that these attributes are ⁻xed over time. As such, in further examples, the relocation of the products may be assumed to not affect ′i. Alternatively or additionally a degree of uncertainty may differ across instruments, and thus the variance of ′i;k may depend on k. Alternatively or additionally, a positive correlation between ′i;k and ′i;h may be determined and as such §′ may be non-diagonal.

Alternatively or additionally, in equation (2) a SKU may be represented by a specific point in an attribute space. A linear mapping may be specified from the attribute space to the model parameters in equation (1). Furthermore, in some examples, items that are close in attribute space may have similar parameters and, as such, the data may also be used to estimate marketing effectiveness parameters. In sum and in some example embodiments, the combination of equation (1) and equation (2) is configured to generate, such as by the processor 303, an attribute-based sales model.

As is shown in decision operation 1306, an apparatus embodied, for example, by a three dimensional optimization system 104, may include means, such as the store management engine 108, the virtual store optimization engine 120, the optimization library 122, the processor 303 or the like, for determining whether a current arrangement results in the highest margin value. In some examples, the current arrangement may be compared to a prior arrangement, a current layout or the like. For example, as each arrangement is generated and an increase value is determined in operation 1304, the arrangement with the greatest increase value may be stored unless an arrangement with a greater increase value is determined. In other examples, a margin threshold may be determined, such that an arrangement with an increase value above the threshold may be chosen. In an instance in which the current arrangement does not result in the highest margin value, then the method restarts at operation 1302.

In an instance in which the current arrangement does result in the highest margin value, then the as is shown in decision operation 1308, an apparatus embodied, for example, by a three dimensional optimization system 104, may include means, such as the store management engine 108, the virtual store optimization engine 120, the optimization library 122, the processor 303 or the like, for determining whether a current arrangement complies with layout rules. Layout rules may include, but are not limited to, SKU weights, SKU volumes, requirements to stock certain SKUs, groupings of related SKUs and/or the like. In an instance in which the current arrangement does not result in an arrangement that complies with the layout rules, then the method restarts at operation 1302.

In an instance in which the current arrangement does result in an arrangement that complies with the layout rules or constraints, then the as is shown in operation 1310, an apparatus embodied, for example, by a three dimensional optimization system 104, may include means, such as the store management engine 108, the virtual store optimization engine 120, the optimization library 122, the processor 303 or the like, for assigning the defined spatial location of the one or more stock keeping units based on the current arrangement.

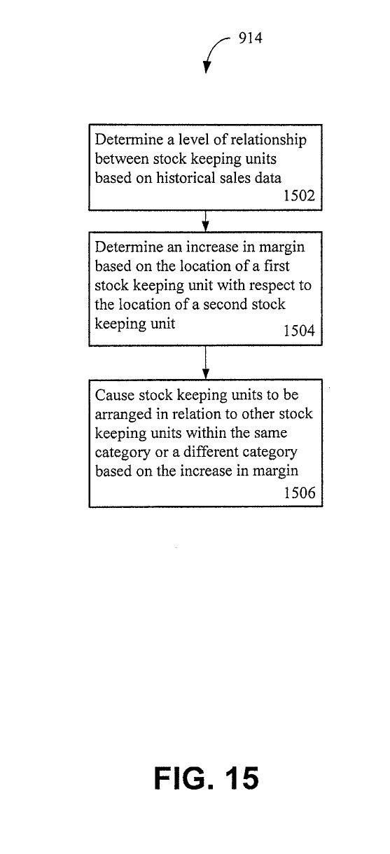

FIG. 14 is a flowchart illustrating an example method 912 for optimizing category interdependency. In some examples, category interdependency may describe the correlation of sales performance from SKU's associated with end use, but not necessarily in the same category. For example placing eggs and bacon in close proximity. As such, the methods of FIGS. 14 and 15 are configured to provide a recommender system.

As is shown in operation 1402, an apparatus embodied, for example, by a three dimensional optimization system 104, may include means, such as the store management engine 108, the virtual store optimization engine 120, the optimization library 122, the processor 303 or the like, for determining a level of relationship between categories based on historical sales data. As is shown in operation 1404, an apparatus embodied, for example, by a three dimensional optimization system 104, may include means, such as the store management engine 108, the virtual store optimization engine 120, the optimization library 122, the processor 303 or the like, for determining an increase in margin based on the location of a first category with respect to the location of a second category. As is shown in operation 1406, an apparatus embodied, for example, by a three dimensional optimization system 104, may include means, such as the store management engine 108, the virtual store optimization engine 120, the optimization library 122, the processor 303 or the like, for causing categories to be arranged in relation to other categories based on an increase in margin.

FIG. 15 is a flowchart illustrating an example method 914 for optimizing SKU interdependency. As is shown in operation 1502, an apparatus embodied, for example, by a three dimensional optimization system 104, may include means, such as the store management engine 108, the virtual store optimization engine 120, the optimization library 122, the processor 303 or the like, for determining a level of relationship between stock keeping units based on historical sales data. As is shown in operation 1504, an apparatus embodied, for example, by a three dimensional optimization system 104, may include means, such as the store management engine 108, the virtual store optimization engine 120, the optimization library 122, the processor 303 or the like, for determining an increase in margin based on the location of a first stock keeping unit with respect to the location of a second stock keeping unit. As is shown in operation 1506, an apparatus embodied, for example, by a three dimensional optimization system 104, may include means, such as the store management engine 108, the virtual store optimization engine 120, the optimization library 122, the processor 303 or the like, for causing stock keeping units to be arranged in relation to other stock keeping units within the same category or a different category based on the increase in margin.

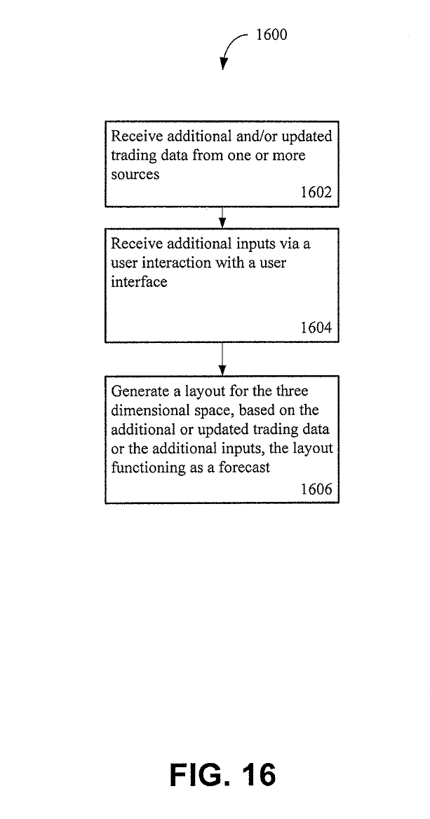

FIG. 16 is a flowchart illustrating forecasting in accordance with example embodiments of the current invention. As is shown in operation 1602, an apparatus embodied, for example, by a three dimensional optimization system 104, may include means, such as the store management engine 108, the virtual store optimization engine 120, the forecasting engine 124, the processor 303 or the like, for receiving additional and/or updated trading data from one or more sources. As is described herein, reference data 132, performance data 134 or aggregation data 136 may be continuously updated and as such the three dimensional space may be continuously optimized. In some examples, the additional and/or updated trading data from the one or more sources may be processed by the forecasting engine to determine an effect on future margin values. As is shown in operation 1604, an apparatus embodied, for example, by a three dimensional optimization system 104, may include means, such as the store management engine 108, the virtual store optimization engine 120, the forecasting engine 124, the processor 303 or the like, for receiving additional inputs via a user interaction with a user interface. In some example embodiments, a user may place a SKU in a particular location to determine the effect of that placement on margin value. In such cases, the forecasting engine may be configured to provide an estimate of a future effect on margin value. As is shown in operation 1606, an apparatus embodied, for example, by a three dimensional optimization system 104, may include means, such as the store management engine 108, the virtual store optimization engine 120, the forecasting engine 124, the processor 303 or the like, for generating a layout for the three dimensional space, based on the additional or updated trading data or the additional inputs, the layout functioning as a forecast.

Advantageously, for example, the apparatus, method and computer program product described herein are configured to enable a real time via, such as via a user interface, of profitability or high margin hotspots throughout a three dimensional space. Further, the combination of metrics for space allocation to the functions or time and sales margin on a per category or per SKU basis is enabled based on the apparatus, method and computer program product described herein. Further and in some example embodiments, the apparatus, method and computer program product described herein may be combined with existing POS and/or ERP systems or may operate as a stand-alone three dimensional space management system.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for optimizing a layout of a multi-dimensional space comprising:
receiving structural data that describes an available volumetric area for the placement of the one or more units in the three dimensional space;
determining a margin value for one or more units in a three dimensional space;
applying one or more optimizations to the one or more units based on the margin value assigned to the one or more units;
determining at least one unit of the one or more units to be included in the three dimensional space based at least in part on the one or more optimizations applied and the margin value assigned to the one or more units;
determining a volumetric area of the three dimensional space to be occupied by the at least one unit determined to be included in the three dimensional space, the volumetric area determined based at least in part on the one or more optimizations applied and the margin value assigned to the one or more units;
assigning a spatial location to the at least one unit determined to be included in the three dimensional space, the spatial location assigned based at least in part on the one or more optimizations applied and the margin value assigned to the one or more units; and
determining an arrangement of the one or more units in the three dimensional space based at least in part on a determined unit interdependency.

2. A method according to claim 1, wherein the margin value for a unit of the one or more units is determined as a function of a volume occupied by the unit of the one or more units in the three dimensional space.

3. A method according to claim 1, further comprising:
receiving trading data relating to the one or more units, wherein at least a portion of the trading data identifies a margin value for the one or more units.

4. A method according to claim 3, wherein the trading data comprises at least one of reference data, performance data or aggregation data.

5. A method according to claim 1, further comprising:
determining the margin value for a unit of the one or more units based on one or more of historical sales data of the unit, real time sales data of the unit, current economic data or current projection data.

6. A method according to claim 1, wherein the one or more units comprise at least one of a plurality of categories or a plurality of stock keeping units.

7. An apparatus for optimizing a layout of a multi-dimensional space comprising:
at least one processor; and
at least one memory including computer program code, the at least one memory and the computer program code configured to, with the at least one processor, cause the apparatus to at least:
receive structural data that describes an available volumetric area for the placement of the one or more units in the three dimensional space.
determine a margin value for one or more units in a three dimensional space;
apply one or more optimizations to the one or more units based on the margin value assigned to the one or more units;
determine at least one unit of the one or more units to be included in the three dimensional space based at least in part on the one or more optimizations applied and the margin value assigned to the one or more units;
determine a volumetric area of the three dimensional space to be occupied by the at least one unit determined to be included in the three dimensional space, the volumetric area determined based at least in part on the one or more optimizations applied and the margin value assigned to the one or more units;
assign a spatial location to the at least one unit determined to be included in the three dimensional space, the spatial location assigned based at least in part on the one or more optimizations applied and the margin value assigned to the one or more units; and
determine an arrangement of the one or more units in the three dimensional space based at least in part on a determined unit interdependency.

8. An apparatus according to claim 7, wherein the margin value for a unit of the one or more units is determined as a function of a volume occupied by the unit of the one or more units in the three dimensional space.

9. An apparatus according to claim 7, wherein the at least one memory including the computer program code is further configured to, with the at least one processor, cause the apparatus to:
receive trading data relating to the one or more units, wherein at least a portion of the trading data identifies a margin value for the one or more units.

10. An apparatus according to claim 9, wherein the trading data comprises at least one of reference data, performance data or aggregation data.

11. An apparatus according to claim 7, wherein the at least one memory including the computer program code is further configured to, with the at least one processor, cause the apparatus to:
determine the margin value for a unit of the one or more units based on one or more of historical sales data of the unit, real time sales data of the unit, current economic data or current projection data.

12. An apparatus according to claim 7, wherein the one or more units comprise at least one of a plurality of categories or a plurality of stock keeping units.

13. A computer program product for optimizing a layout of a multi-dimensional space comprising:
at least one computer readable non-transitory memory medium having program code instructions stored thereon, the program code instructions which when executed by an apparatus cause the apparatus at least to:
determine a margin value for one or more units in a three dimensional space;
receive structural data that describes an available volumetric area for the placement of the one or more units in the three dimensional space;
apply one or more optimizations to the one or more units based on the margin value assigned to the one or more units;
determine at least one unit of the one or more units to be included in the three dimensional space based at least in part on the one or more optimizations applied and the margin value assigned to the one or more units;
determine a volumetric area of the three dimensional space to be occupied by the at least one unit determined to be included in the three dimensional space, the volumetric area determined based at least in part on the one or more optimizations applied and the margin value assigned to the one or more units;
assign a spatial location to the at least one unit determined to be included in the three dimensional space, the spatial location assigned based at least in part on the one or more optimizations applied and the margin value assigned to the one or more units; and
determine an arrangement of the one or more units in the three dimensional space based at least in part on a determined unit interdependency.

14. A computer program product according to claim 13, wherein the margin value for a unit of the one or more units is determined as a function of a volume occupied by the unit of the one or more units in the three dimensional space.

15. A computer program product according to claim 13, further comprising program code instructions configured to:
receive trading data relating to the one or more units, wherein at least a portion of the trading data identifies a margin value for the one or more units.

16. A computer program product according to claim 15, wherein the trading data comprises at least one of reference data, performance data or aggregation data.

17. A computer program product according to claim 13, further comprising program code instructions configured to:

18. A computer program product according to claim 13, further comprising program code instructions configured to:
determine the margin value for a unit of the one or more units based on one or more of historical sales data of the unit, real time sales data of the unit, current economic data or current projection data.

19. A computer program product according to claim 13, wherein the one or more units comprise at least one of a plurality of categories or a plurality of stock keeping units.
